(19) United States
(12) Patent Application Publication
(10) Pub. No.: US 2024/0182632 A1
(43) Pub. Date: Jun. 6, 2024

(54) POLYMER COMPRISING LONG CHAIN HYDROXY ACIDS

(71) Applicant: EVONIK OPERATIONS GMBH, Essen (DE)

(72) Inventors: Tim SMOLNIK, Münster (DE); Erik KERSTEN, Udenheim (DE); Rolf SCHNEIDER, Gründau-Rothenbergen (DE)

(73) Assignee: EVONIK OPERATIONS GMBH, Essen (DE)

(21) Appl. No.: 18/556,282

(22) PCT Filed: Apr. 11, 2022
(86) PCT No.: PCT/EP2022/059610

§ 371 Date: Oct. 19, 2023

(30) Foreign Application Priority Data
Apr. 20, 2021 (EP) 21169272.8

(51) Int. Cl. C08G 63/06; C08G 63/85; C08G 63/87; C08J 5/18

(52) U.S. Cl. CPC C08G 63/06; C08G 63/85; C08G 63/87; C08J 5/18; C08J 2367/04

(57) ABSTRACT

A process for preparing a polymer from a 3-hydroxy carboxylic acid as monomer comprising at least 8 carbon atoms where the polymerisation reaction is conducted at a temperature of from 100° C. to 180° C. while removing water from the reaction mixture, wherein 50 to 100 mol-% of the monomers used are 3-hydroxy carboxylic acids comprising at least 8 carbon atoms. A polymer comprising units based on 3-hydroxy carboxylic acid, comprising at least 8 carbon atoms, characterized in that of from 60 to 100 mol-% of the units are based on beta-hydroxy carboxylic acids, comprising at least 8 carbon atoms and films, foils, flexible packaging, and barrier coatings comprised of said polymers.

The present invention relates to a process for preparing a polymer from at least one 3-hydroxy carboxylic acid as monomer, wherein the 3-hydroxy carboxylic acid comprises at least 8 carbon atoms, preferably of from 10 to 24 carbon atoms and that the polymerisation reaction is conducted at a temperature of from 100° C. to 180° C., preferably at a temperature of from 110° C. to 140° C. while removing water from the reaction mixture, and wherein 50 to 100 mol-% of the monomers used are 3-hydroxy carboxylic acids comprising at least 8 carbon atoms, to a polymer comprising units based on 3-hydroxy carboxylic acid comprising at least 8 carbon atoms, wherein 60 to 100 mol-% of the units are based on beta-hydroxy carboxylic acids comprising at least 8 carbon atoms, to a mixture comprising dimers of 3-hydroxy carboxylic acid, characterized in that it comprises of from 50 to 80 parts by weight 3-hydroxy decanoic acid dimer (D-C10-C10), of from 5 to 15 parts by weight dimer obtained from 3-hydroxy decanoic acid and 3-hydroxy octanoic acid (D-C8-C10), of from 5 to 15 parts by weight hydroxy decanoic acid, of from 1 to 10 parts by weight dimer obtained from 3-hydroxy decanoic acid and 3-hydroxy dodecanoic acid (D-C10-C12) and of from 1 to 10 parts by weight dimer obtained from 3-hydroxy decanoic acid and 3-hydroxy dodecenoic acid (D-C10-C12:1), and to the use of the polymers as films, foils, flexible packaging, or barrier coatings.

### STATE OF THE ART

Polyhydroxyalkanoates or PHAs are polyesters produced in nature by numerous microorganisms, including through bacterial fermentation of sugars or lipids. When produced by bacteria they serve as both a source of energy and as a carbon store. More than 150 different monomers can be combined within this family to give materials with extremely different properties. These plastics are biodegradable and are used in the production of bioplastics (Source: en.wikipedia.org, Wikidata item ID: Q425079).

Commercially available PHAs are produced by fermentation processes using different bacteria. Disadvantages of this biosynthesis are changing product qualities and the need to include a cost intensive purification step. A further disadvantage is that it is not possible to control der polymer properties and polymer composition respectively.

H. Tsuji, Journal of Applied Polymer Science, Vol. 110, 3954-3962 (2008) and H.Tsuji and S.Shimizu described in Polymer 53, 2012 the use of para-toluene sulfonic acid (pTSA) as catalyst for preparing polylactid-derivates.

Y. Kimura; Polymer 42 (2001) 5059-5062 described the use of a tin chloride dihydrate/pTSA combination as catalyst for preparing polylactid-derivates.

Therefore, there is still a need to provide bio-based, biodegradable, and film-forming polymers and processes to prepare those polymers.

The problem to be solved by the present invention was therefore, to provide polymers based on 3-hydroxy carboxylic acids that have defined properties and a defined composition and a process for producing these polymers.

### DISCLOSURE OF THE INVENTION

Surprisingly it has been found that this problem can be solved by the process and polymer according to the claims.

The objectives are achieved by the invention by providing a process for preparing a polymer from at least one 3-hydroxy carboxylic acid as monomer, wherein the 3-hydroxy carboxylic acid comprises at least 8 carbon atoms and that the polymerisation reaction is conducted at a temperature of from 100° C. to 180° C. while removing water from the reaction mixture, and wherein 50 to 100 mol-% of the monomers used are 3-hydroxy carboxylic acids comprising at least 8 carbon atoms.

The present invention also provides a polymer comprising units based on 3-hydroxy carboxylic acid comprising at least 8 carbon atoms, wherein of from 60 to 100 mol-% of the units are based on beta-hydroxy carboxylic acids comprising at least 8 carbon atoms.

The present invention also provides a mixture comprising dimers of 3-hydroxy carboxylic acid, that comprises of from 50 to 80 parts by weight of 3-hydroxy decanoic acid of dimer (D-C10-C10), of from 5 to 15 parts by weight of dimer obtained from 3-hydroxy decanoic acid and 3-hydroxy octanoic acid (D-C8-C10), of from 5 to 15 parts by weight of hydroxy decanoic acid, of from 1 to 10 parts by weight of dimer obtained from 3-hydroxy decanoic acid and 3-hydroxy dodecanoic acid (D-C10-C12) and of from 1 to 10 parts by weight of dimer obtained from 3-hydroxy decanoic acid and 3-hydroxy dodecenoic acid (D-C10-C12:1).

The present invention further provides the use of the polymers as foils, films, flexible packaging, or barrier coatings.

The polymers of the present invention have the advantage that they do not comprise unknown molecules/compounds as this might be the case in polymers produced by a fermentative process.

The chemical, physical, and mechanical properties of the polymers of the present invention, especially melting temperature and glass transition temperature can be designed by using different process parameters or using additional comonomers, e.g. glycolic acid or lactic acids.

By using (small amounts of) preferably bio-based cross-linkers like for example tartaric acid or citric acid bio-based polymers with high molecular weights are available.

The polymers, processes, and uses (methods to use) according to the invention are described by way of example hereinafter, without any intention that the invention be restricted to these illustrative embodiments. When ranges, general formulae or classes of compounds are specified below, these are intended to encompass not only the corresponding ranges or groups of compounds which are explicitly mentioned but also all subranges and subgroups of compounds which can be obtained by leaving out individual values (ranges) or compounds. Where documents are cited in the context of the present description, their content shall fully form part of the disclosure content of the present invention, particularly in respect of the matters referred to. Percentages specified hereinbelow are by weight unless otherwise stated. Where average values are reported hereinafter, these are the numerical average, unless stated otherwise. Where properties of a material are referred to hereinafter, for example viscosities or the like, these are the properties of the material at 25° C., unless stated otherwise. Where chemical (empirical) formulae are used in the present invention, the specified indices may be not only absolute numbers but also average values.

The process for preparing a polymer from at least one 3-hydroxy carboxylic acid as monomer according to the invention is characterized in that the 3-hydroxy carboxylic acid comprises at least 8 carbon atoms, preferably of from 10 to 24 carbon atoms, more preferably 14 to 20 carbon atoms, and that a polymerisation reaction is conducted at a temperature of from 100° C. to 180° C., preferably of from 110° C. to 140° C. while removing water from the reaction mixture, and wherein 50 to 100 mol-% of the monomers used are 3-hydroxy carboxylic acids comprising at least 8 carbon atoms.

The polymerization reaction might be performed at atmospheric pressure. Preferably the polymerization reaction is conducted under reduced pressure, more preferably at a pressure of from 0.1 to 10 mbar (10 to 1000 Pa), most preferably 1 to 4 mbar (100 to 400 Pa).

The polymerization reaction might be conducted in the presence of air. However, it is more preferred to conduct the polymerization reaction in the absence of oxygen, preferably in an inert gas atmosphere, more preferably using nitrogen as inert gas.

It might be advantageous to perform the polymerization reaction in the absence of oxygen in a nitrogen atmosphere and/or at a reduced pressure of from 1 to 4 mbar. It might be advantageous to change the conditions periodically.

The polymerization reaction is preferably conducted as a melt polycondensation. Therefore, the monomers as well as the co-components solid at room temperature are preferably initially charged and melted if necessary.

The polymerization reaction is preferably conducted in the course 2 to 100 hours, preferably 5 to 75 hours, and more preferably 6 to 50 hours.

In the process according to the invention the monomer is preferably selected from the group consisting of 3-hydroxy tetra decanoic acid (3-OH—C14), 3-hydroxy palmitic acid (3-OH—C16), 3-hydroxy dodecanoic acid (3-OH—C12), and 3-hydroxy decanoic acid (3-OH—C10) or its dimer, preferably its dimer.

In the process of the invention preferably 50 to 99 mol-% of the monomers used are 3-hydroxy carboxylic acids comprising at least 8 carbon atoms, preferably 10 to 24 carbon atoms, more preferably 14 to 20 carbon atoms and most preferably are selected from the group consisting of 3-hydroxy tetra decanoic acid (3-OH—C14), 3-hydroxy palmitic acid (3-OH—C16), 3-hydroxy dodecanoic acid (3-OH—C12), and 3-hydroxy decanoic acid (3-OH—C10) or its dimer, preferably its dimer.

It might be advantageous if the process according to the invention comprises a dimerization step conducted before the polymerisation reaction, wherein 3-hydroxy decanoic acid (3-OH—C10) is dimerized, preferably using one or more microorganisms. Preferably the dimerization step is conducted as fermentation with a recombinant microorganism harboring the enzymatic machinery to intercept B-hydroxy fatty acids from the fatty acid biosynthesis pathway, dimerize them and secrete them into the fermentation broth. To that end preferably Pseudomonas putida KT2440 was equipped with the enzyme RhIA from Pseudomonas aeruginosa PAO1. The resulting strain can be subjected to fed-batch fermentation preferably in a mineral salts medium preferably with dextrose as sole carbon source preferably under carbon-limiting conditions.

At the end of fermentation, the fermentation broth is preferably subjected to thermal inactivation. After mixing the inactivated broth, the biomass is removed, preferably by filtration. The remaining material is preferably acidified to form a biphasic system. After phase separation, the product phase (oil phase) is preferably washed with demineralized water and after that subjected to a polishing centrifugation step.

Since the starting material for the dimerization step is preferably dextrose, the resulting product is preferably a mixture comprising 3-hydroxy carboxylic acids and its dimers. Therefore, in the process according to the invention preferably a mixture comprising 3-hydroxy carboxylic acids is used as monomer, wherein the mixture comprises of from of from 50 to 80 parts by weight 3-hydroxy decanoic acid dimer (D-C10-C10), of from 5 to 15 parts by weight dimer obtained from 3-hydroxy decanoic acid and 3-hydroxy octanoic acid (D-C8-C10), of from 5 to 15 parts by weight hydroxy decanoic acid, of from 1 to 10 parts by weight dimer obtained from 3-hydroxy decanoic acid and 3-hydroxy dodecanoic acid (D-C10-C12) and of from 1 to 10 parts by weight dimer obtained from 3-hydroxy decanoic acid and 3-hydroxy dodecenoic acid (D-C10-C12:1). Further components of the mixture might be for example water and/or processing additives, e.g. defoamer. The mixture preferably does not comprise any microorganisms. Most preferably the mixture comprises of from 60 to 75% by weight D-C10-C10, about 12.5 to 15.5% by weight D-C8-C10, about 5 to 10% by weight hydroxy decanoic acid, about 2.5 to 7.5% by weight D-C10-C12, and about 2.5 to 7.5% by weight D-C10-C12:1 based on the total weight of these components.

It might be advantageous, that one or more further hydroxy acids having less than 8 carbon atoms and not being 3-hydroxy carboxylic acids are used as co-components. Those co-components might either be used as co-monomers or as cross-linkers. Preferred co-components are selected from one or more alpha-hydroxy carboxylic acids or one or more carboxylic acids having two or more carboxyl groups or mixtures thereof. The alpha-hydroxy carboxylic acids are preferably used as comonomers. Glycolic acid or lactic acid is preferably used as alpha-hydroxy carboxylic acids. The carboxylic acids having two or more carboxyl groups or mixtures thereof are preferably used as crosslinkers. Tartaric acid, citric acid, or 1,2,3,4-butane tetracarboxylic acid are preferably used as carboxylic acids having two or more carboxyl groups.

The co-components might be used directly or after an oligomerisation step. If the co-components are used as oligomers, the oligomers preferably comprise of from two to ten monomer units. A co-component that might preferably be used as an oligomer is oligomeric glycolic acid.

The polymerisation reaction can be conducted with or without the presence of a catalyst. More preferably the polymerisation reaction is conducted in the presence of a catalyst.

The catalyst might be selected from Lewis acids, more preferably organic tin or titanium compounds, most preferably titan tetra butanoate or tin octanoate, or Brönsted acids, more preferably para-toluene sulfonic acid (pTSA), inorganic acids, or acidic matrix material. Preferably the polymerization reaction according to the invention is conducted using a Brönsted acid as catalyst, preferably using pTSA or sulfuric acid, preferably a 50 weight-% sulfuric acid, most preferably using pTSA.

The amount of catalyst used (if any) is preferably of from 0.01 to 10% by weight, preferably of from 0.5 to 5% by weight, and more preferably of from 0.75 to 3% by weight based on the sum of the mass of the monomers, the co-components and the catalyst present in the reaction mixture. Most preferably pTSA is used as catalyst in an amount of from 0.5 to 5% by weight, and more preferably of from 0.75 to 3% by weight based on the sum of the mass of the monomers, the co-components and the catalyst present in the reaction mixture.

It may be advantageous to add further additives and processing auxiliaries, such as antioxidants or color stabilizers, to the reaction mixture.

In the process according to the invention the polymerisation reaction is preferably conducted in the absence of any microorganism. Therefore, the polymerization reaction is preferably not conducted as a fermentation process.

It might be advantageous if the process according to the invention comprises a drying step before starting the polymerization reaction. In the drying step the monomer and co-components, if any, are dried at elevated temperature, preferably at a temperature of from 95 to 150° C., and flush with nitrogen. The drying step is preferably conducted for a period of from 1 minute to 4 h, more preferably of from 1.5 to 2.5 h. After the drying step the catalyst is introduced to the reaction mixture and/or the reaction mixture is brought to the reaction temperature, preferably to a reaction temperature of from 130° C. to 150° C.

It might also be advantageous if the process according to the invention comprises a purification step after the polymerisation reaction. In a preferred purification step the reaction mixture obtained in the polymerization reaction is solved in a solvent, preferably tetrahydrofuran and neutralized using 5 equivalents of NaHCO₃ or neutral aluminum oxide (ALOX). The mixture is then given through a filter paper to remove the solids. From this solution the solvent is removed under reduced pressure.

In a more preferred purification step the reaction mixture obtained from the polymerization reaction is solved in a solvent, preferably tetrahydrofuran. This solution is then put onto neutral aluminum oxide (ALOX) a (glass) column is filled. Then the glass column is rinsed with more solvent, preferably THF. The amount of solvent (volume) used is preferably equal to the volume of the column. From the solution obtained at outlet of the column the solvent is removed under reduced pressure.

The Polymer according to the invention comprising units based on 3-hydroxy carboxylic acid, comprising at least 8 carbon atoms, is characterized in that of from 60 to 100 mol-% of the units are based on beta-hydroxy carboxylic acids, comprising at least 8 carbon atoms, preferably of from 10 to 24 carbon atoms, more preferably 14 to 20 carbon atoms. Preferably 80 to 99 mol-% of the units the polymer are based on 3-hydroxy carboxylic acids comprising at least 10 carbon atoms, preferably 14 to 24 carbon atoms and most preferably are selected from the group consisting of 3-hydroxy tetra decanoic acid (3-OH—C14), 3-hydroxy palmitic acid (3-OH—C16), 3-hydroxy dodecanoic acid (3-OH—C12), and 3-hydroxy decanoic acid (3-OH—C10) or its dimer, preferably its dimer.

The polymer according to the invention is preferably obtained by a process according to the invention as described above.

The polymer according to the invention preferably has a weight averaged molecular weight Mw, determined by the method given in the description, of at least 1500 g/mol, more preferably of from 3000 to 15000 g/mol.

The polymers according to the invention or obtained by a process according to the invention can be used as or to produce films, foils, flexible packaging, or barrier coatings.

The subject-matter of the present invention is elucidated in detail in the examples which follow, without any intention that the subject-matter of the present invention be restricted to these.

### EXAMPLES

### 1. Test Methods

a) Determination of Melting Temperature Tm₁ (First Heating) and Tm₂ (Second Heating) and Melting Enthalpy as Well as Glass Transition Temperature Tg

The thermal properties of the polyesters used in the context of the present invention are determined by differential scanning calorimetry (DSC) in accordance with the DSC method DIN 53765. The values of the second heating interval are stated, and the heating rate was 10 K/min. Nitrogen was used in an amount of 30 mL/min. The results are given in tables 4 and 5.

### b) Determination of Viscosity

The viscosity of the polyesters produced and of the reaction products of polyester and diisocyanate was determined in accordance with DIN EN ISO 3219 in Pa—s using a rotational viscometer MCR302 of Anton Parr GmbH (length of cylinder 40 mm, diameter of cylinder 26.6 mm) at the temperature specified in each case.

### c) Determination of Molecular Weight

The number-average molecular weight and the weight-average molecular weight of the polyesters according to the invention is determined in accordance with DIN 55672-1 by means of gel permeation chromatography in tetrahydrofuran as eluent and polymethacrylate PMMA standard for calibration.

### 2. Raw Materials Used

TABLE 1
Raw materials used, trade names and producer

| | | Molecular | | |
|---|---|---|---|---|
| Chemical name | CAS no. | mass [g/mol] | Abbreviation | Producer |
| DL-erythro-Aleuritic acid | 533-87-9 | 304.43 | AlA | Taros Chemicals |
| p-toluene sulfonic acid * | 6192-52-5 | 190.22 | pTSA | Sigma-Aldrich |
| H2O | | | | |
| 3-hydroxy palmitic acid | 2398-34-7 | 272.42 | 3HPA | Taros Chemicals |
| 3-hydroxy decanoic acid | 6192-52-5 | 358.5 | 3HDAD | produced as |
| dimer | | | | described below |
| Neutral aluminium oxide | 1344-28-1 | 101.96 | AlOx | Sigma-Aldrich |
| Acidic aluminium oxide | 1344-28-1 | 101.96 | AlOx | Sigma-Aldrich |
| H₂SO₄ (50 wt. %) | 7664-93-9 | 98.08 | H₂SO₄ (50) | VWR |
| 3-hydroxy tetradecanoic | 1961-72-4 | 244.38 | 3HTD | Taros Chemicals |
| acid | | | | |
| titan tetrabutanolate | 5593-70-4 | 340.36 | TBT | Sigma-Aldrich |
| tin(II)-2-ethylhexanoate | 301-10-0 | 405.12 | TEH | Sigma-Aldrich |
| Aqueous L-lactic acid | 79-33-4 | 90.08 | LA80 | Carl Roth GmbH + |
| (80% by weight) | | | | Co KG |
| Aqueous DL-lactic acid | 50-21-5 | 90.08 | LA90 | Carl Roth GmbH + |
| (90% by weight) | | | | Co KG |
| L-tartaric acid | 87-69-4 | 150.09 | TA | Sigma-Aldrich |
| Glycolic acid | 79-14-1 | 76.05 | GA | Sigma-Aldrich |
| Oligomeric GA | | | OGA | produced as |
| | | | | described below |
| Tetrahydrofuran | 109-99-9 | 72.11 | THF | Sigma-Aldrich |
| 1,2,3,4-butane | 1703-58-8 | 234.16 | BTA | J&K Scientific |
| tetracarboxylic acid | | | | |

Taros Chemicals = Taros Chemicals GmbH & Co. KG
Sigma-Aldrich = Sigma-Aldrich Chemie GmbH

2.a Production of 3-Hydroxy Decanole Acid Dimer 3-hydroxy decanoic acid dimer was produced by fermentation with a recombinant microorganism harboring the enzymatic machinery to intercept β-hydroxy fatty acids from the fatty acid biosynthesis pathway, dimerize them and secrete them into the fermentation broth. To that end Pseudomonas putida KT2440 was equipped with the enzyme RhIA from Pseudomonas aeruginosa PAO1. The resulting strain was subjected to fed-batch fermentation in a mineral salts medium with dextrose as sole carbon source under carbon-limiting conditions. At the end of fermentation the fermentation broth was subjected to thermal inactivation. After mixing the inactivated broth, the biomass was removed by filtration. The remaining material was acidified. This resulted in the formation of a biphasic system. After phase separation, the product phase was washed with demineralized water. The final product was subjected to a polishing centrifugation step. The product mixture comprises about 57 parts by weight D-C10-C10, about 12 parts by weight D-C8-C10, about 6 parts by weight hydroxy decanoic acid, about 4 parts by weight D-C10-C12, about 4 parts by weight D-C10-C12:1 and about 2 parts by weight β-hydroxy fatty acid dimers with other chain lengths and comprises about 67.9% by weight D-C10-C10, about 14.9% by weight D-C8-C10, about 7.3% by weight hydroxy decanoic acid, about 4.6% by weight D-C10-C12, and about 5.3% by weight D-C10-C12:1 based on the total weight of these products.

### 2.b Production of Oligomeric Glycolic Acid

Glycolic acid was added to a 250 mL flask equipped with distillation bridge and stirrer in a nitrogen stream. The temperature was raised within 2 hours to a reaction temperature of 150° C. while stirring and left at that temperature for 5 hours. The reaction mixture was then allowed to cooled down to room temperature by terminating heating. A milky liquid was obtained, that was again added to a 250 mL flask equipped with distillation bridge and stirrer in a nitrogen stream. The temperature was raised within 2 hours to a reaction temperature of 180° C. while stirring and left at that temperature for 5 hours. The melt was emptied into a crystallizing dish and after cooling of the melt to room temperature the oligomeric glycolic acid was obtained as colorless solid.

### 3. Synthesis of Polymers

The reaction conditions as well as the amount of materials and the process parameters used are given in table 2a and 2b and in the description of the different process below. Product parameters/characteristics are given in table 3a, 3b, 4, and 5.

The experiments were performed in an apparatus comprising a flask (size depends on the amount of raw materials used) equipped with a magnetic stirrer, a Y-piece connecting the flask with a membrane pump (vacuum pump) and a nitrogen line. The flask was placed in an oil bath for heating. In some experiments the flask was further equipped with a distillation (Claisen) bridge.

3a. Process I: (Catalyst Added in Two Steps)

The monomer was melted in vacuum (membrane pump) at about 5° C. above the melting temperature of the monomer and degassed at that temperature for 1 h. Then a first amount of catalyst was added using an Eppendorf pipette. The reaction mixture was heated under vacuum using an oil bath to the reaction temperature. After 24 h a second amount of catalyst was added. The status of the reaction was analyzed by GPC using samples taken from time to time from the reaction mixture using a metal syringe.

3b. Process II (No Catalyst)

The monomer and co-component (if any) were melted in vacuum (membrane pump) at about 5° C. above the melting temperature of the monomer and heated under vacuum using an oil bath to the reaction temperature. The status of the reaction was analyzed by GPC using samples taken from time to time from the reaction mixture using a metal syringe.

3c. Process IIa (No Catalyst)

The monomer was melted in vacuum (membrane pump) at about 5° C. above the melting temperature of the monomer. Then the co-component was added and the reaction mixture was heated under vacuum using an oil bath to the reaction temperature. The status of the reaction was analyzed by GPC using samples taken from time to time from the reaction mixture using a metal syringe.

3d. Process III: (Catalyst Added in One Step)

The monomer was melted in vacuum (membrane pump) at about 5° C. above the melting temperature of the monomer and degassed at that temperature for 1 h. Then the catalyst was added using an Eppendorf pipette. The reaction mixture was heated under vacuum (only 150 mbar for PHA_014) using an oil bath to the reaction temperature. The status of the reaction was analyzed by GPC using samples taken from time to time from the reaction mixture using a metal syringe.

3e. Process IIIa: (Catalyst Added in One Step)

The monomer was melted in vacuum (membrane pump) at about 5° C. above the melting temperature of the monomer and heated to reaction temperature and held there for 24 h using an oil bath. Then the catalyst was added using an Eppendorf pipette. The reaction mixture was further held under vacuum at the reaction temperature. The status of the reaction was analyzed by GPC using samples taken from time to time from the reaction mixture using a metal syringe.

3f. Process IV

Monomer, co-component (if any), and catalyst were introduced into a 100 mL flask and heated to reaction temperature under nitrogen stream. After 1.5 h vacuum was applied to the reaction mixture using a membrane pump. The status of the reaction was analyzed by GPC using samples taken from time to time from the reaction mixture using a metal syringe.

3g. Process IVa

Monomer, co-component (if any), and catalyst were introduced into a 500 mL flask and heated to reaction temperature under nitrogen stream. After 1.5 h vacuum was applied to the reaction mixture using a membrane pump. The status of the reaction was analyzed by GPC using samples taken from time to time from the reaction mixture using a metal syringe.

3h. Process V

Monomer and co-component (if any) were introduced into a 100 mL flask and melted heated. The catalyst was added and the reaction mixture was heated to reaction temperature under nitrogen stream. After 1.5 h vacuum was applied to the reaction mixture using a membrane pump. The status of the reaction was analyzed by GPC using samples taken from time to time from the reaction mixture using a metal syringe.

TABLE 2a
Process parameters

| | Monomer/ | Comonomer/ | Catalyst/ | Reaction | Reaction | | |
|---|---|---|---|---|---|---|---|
| Example | amount [g] | amount [g] | amount [g] | Temperature | time | | Process |
| 3.1 | 3HTDA/10.009 | | TBT/0.15 | 110° C. | 72 | h | I |
| | | | TBT/0.1 | | | | |
| 3.2 | 3HTDA/10.020 | | TBT/0.2 | 110° C. | 72 | h | I |
| | | | TBT/0.2 | | | | |
| 3.3 | 3HTDA/10.009 | | TBT/0.1 | 140° C. | 24 | h | III |
| 3.4 | 3HTDA/10.007 | | TBT/0.4 | 140° C. | 8 | h | III |
| 3.5 | 3HTDA/10.003 | | TEH/0.1 | 130° C. | 8 | h | IIIa |
| 3.6 | 3HTDA/10.020 | | TEH/0.25 | 130° C. | 29 | h | III |
| 3.7 | 3HTDA/10.003 | LA90/0.662 | | 140 | 102 | h | II |
| 3.8 | 3HPA/70.0 | | pTSA/1.75 | 130° C. | 6.5 | h | IVa |
| 3.9 | 3HTDA/70.0 | | pTSA/1.75 | 130° C. | 6.5 | h | V |
| 3.10 | 3HTDA/10.001 | GA/0.622 | | 140° C. | 101 | h | IIa |
| 3.11 | 3HPA/10.004 | | pTSA/0.015 | 140° C. | 24 | h | IV |
| 3.12 | 3HPA/10.001 | | pTSA/0.051 | 140° C. | 24 | h | IV |
| 3.13 | 3HPA/10.006 | | pTSA/0.108 | 110° C. | 24 | h | IV |
| 3.14 | 3HPA/10.005 | | pTSA/0.108 | 140° C. | 24 | h | IV |
| 3.15 | 3HPA/10.006 | | H₂SO₄(50)/0.018 | 140° C. | 24 | h | V |
| 3.16 | 3HPA/10 | | H₂SO₄(50)/0.092 | 140° C. | 24 | h | V |
| 3.17 | 3HPA/10 | GA/.0558 | pTSA/0.267 | 140° C. | 24 | h | IV |
| 3.18 | 3HPA/8 | GA/1.787 | pTSA/0.246 | 140° C. | 24 | h | IV |
| 3.19 | 3HDA/10.018 | | pTSA/0.251 | 140° C. | 24 | h | IV |
| 3.20 | 3HPA/10 | AIA/0.113 | | 140° C. | 24 | h | IV |
| 3.21 | 3HPA/10 | AIA/0.111 | pTSA/0.252 | 140° C. | 7 | h | IV |

TABLE 2b
Process parameters (continued)

| | Monomer/ | Cocomponent/ | Catalyst/amount | Reaction | Reaction | |
|---|---|---|---|---|---|---|
| Example | amount [g] | amount [g] | [g] | Temperature | time | Process |
| 3.22 | 3HPA/10.006 | AIA/1.117 | pTSA/0.278 | 140° C. | 7 h | IV |
| 3.23 | 3HPA/10.002 | | pTSA/0.102 | 110° C. | 30.5 h | IV |
| 3.24 | 3HPA/10.004 | OGA/2.451 | pTSA/0.312 | 140° C. | 7 h | IV |
| 3.25 | 3HPA/5.004 | OGA/4.900 | pTSA/0.248 | 140° C. | 7 h | IV |
| 3.26 | 3HPA/10.005 | AIA/1.118 | | 140° C. | 24 h | IV |
| 3.27 | 3HTDA/120.0 | GA/7.469 | pTSA/3.187 | 140° C. | 7 h | IVa |
| 3.28 | 3HTDA/120.0 | GA/18.678 | pTSA/3.467 | 140° C. | 7 h | IVa |
| 3.29 | 3HTDA/100.0 | GA/24.897 | pTSA/3.125 | 140° C. | 7 h | IVa |
| 3.30 | 3HPA/10.003 | | pTSA/0.101 | 120° C. | 30 h | IV |
| 3.31 | 3HTDA/10.001 | | pTSA/0.251 | 140° C. | 7 h | IV |
| 3.32 | 3HDAD/10.017 | LA80/0.403 | pTSA/0.260 | 140° C. | 7 h | IV |
| 3.33 | 3HDAD/10.007 | | pTSA/0.102 | 130° C. | 30 h | IV |
| 3.34 | 3HPA/10.007 | | pTSA/0.101 | 130° C. | 30 h | IV |
| 3.35 | 3HPA/10.002 | | pTSA/0.100 | 130° C. | 48 h | IV |
| 3.36 | 3HDAD/6.016 | OGA/4.472 | pTSA/0.262 | 140° C. | 7 h | IV |
| 3.37 | 3HPA/5.002 | OGA/4.903 | pTSA/0.249 | 140° C. | 7 h | IV |
| | | BTA/0.111 | | | | |
| 3.38 | 3HPA/10.001 | | pTSA/0.102 | 110° C. | 48 h | IV |
| 3.39 | 3HPA/10.0 | | pTSA/0.250 | 140° C. | 7 h | IV |
| 3.40 | 3HPA/9.5 | TA/0.523 | pTSA/0.102 | 140° C. | 7 h | IV |

### 4. After Treatment

The product obtained in the polymerization reaction was subjected to a drying step or a purification step, if necessary.

### 4a Purification I

The reaction mixture obtained from the polymerization reaction (one of the processes 3a to 3h) was solved in tetrahydrofuran and neutralized using 5 equivalents of NaHCO₃. The mixture obtained was filtered using a standard paper filter.

### 4b Purification II

The reaction mixture obtained from the polymerization reaction (one of the processes 3a to 3h) was solved in tetrahydrofuran. This solution was put onto acid aluminum oxide (ALOX) a glass column was filled with. Then the glass column was rinsed with more THF. The volume of THF used for rinsing equals to the volume of the empty glass column.

### 4c Purification III

The reaction mixture obtained from the polymerization reaction (one of the processes 3a to 3h) was solved in tetrahydrofuran. This solution was put onto neutral aluminum oxide (ALOX) a glass column was filled with. Then the glass column was rinsed with more THF. The volume of THF used for rinsing equals to the volume of the empty glass column.

### 4d Purification IV

The reaction mixture obtained from the polymerization reaction (one of the processes 3a to 3h) was solved in ethyl acetate and neutralized using 5 equivalents of NaHCO₃. The mixture obtained was filtered using a standard paper filter.

If and which kind of after treatment was used is given in table 3a and 3b.

TABLE 3a
Process parameters and results

| | Pressure | Mn | Mw | After reaction | |
|---|---|---|---|---|---|
| Example | [mbar] | [g/mol] | [g/mol] | treatment | Product observation |
| 3.1 | 3 | 1270 | 2000 | | Yellow turbid liquid, solid at 1° C. |
| 3.2 | 3 | 1070 | 2070 | | Slightly yellow turbid liquid |
| 3.3 | 3/2 | 876 | 1770 | | Yellow clear liquid, solid at 1° C. |
| 3.4 | 2 | 876 | 1540 | | Slightly yellow turbid liquid, |
| | | | | | solid at 1° C. |
| 3.5 | 2 | 887 | 1550 | | Yellow milky solid |
| 3.6 | 2 | 891 | 1650 | | Milky solid |
| 3.7 | 2 | 695 | 1660 | | Brown milky solid |
| 3.8 | 1000/2 | 3220 | 8000 | Purification II | Colorless solid |
| 3.9 | 1000/2 | 2570 | 6200 | Purification II | Light brown viscous liquid |
| 3.10 | 2 | 719 | 1830 | | Mixture of milky solid and viscous |
| | | | | | liquid |
| 3.11 | 1000/2 | 995 | 1770 | Purification II | Colorless milky solid |
| 3.12 | 1000/2 | 3710 | 7390 | Purification II | Colorless solid |
| 3.13 | 1000/2 | 4220 | 9120 | Purification II | Brown milky solid |
| 3.14 | 1000/2 | 3500 | 6070 | Purification III | Light brown milky solid |
| 3.15 | 1000/2 | 953 | 1760 | | Slightly yellowish, milky solid |
| 3.16 | 1000/2 | 1220 | 3050 | | Dark brown liquid, solid at 1° C. |
| 3.17 | 1000/2 | 862 | 1840 | Purification III | Light brown solid |
| 3.18 | 1000/2 | 2050 | 3680 | Purification III | Brown viscous liquid |
| 3.19 | 1000/2 | 2220 | 4040 | Purification III | Brown clear viscous liquid |
| 3.20 | 1000/2 | 830 | 1630 | | Slightly yellow milky solid |
| 3.21 | 1000/2 | 2640 | 5570 | Purification II | Light brown milky solid |

TABLE 3b
Process parameters and results (continued)

| | Pressure | Mn | Mw | After reaction | |
|---|---|---|---|---|---|
| Example | [mbar] | [g/mol] | [g/mol] | treatment | Observation |
| 3.22 | 1000/2 | 2950 | 13800 | Purification II | Orange-brown liquid. Solid at 1° C. |
| 3.23 | 1000/2 | 4390 | 10600 | Purification III | Orange-brown liquid. Solid at 1º C. |
| 3.24 | 1000/2 | 2380 | 6810 | Purification | Yellow clear oil. Solid at 1º C. |
| 3.25 | 1000/2 | 4040 | 8550 | Purification I | Light brown sticky solid |
| 3.26 | 1000/2 | 987 | 2940 | | Colorless milky solid |
| 3.27 | 1000/2 | 1880 | 4980 | Purification | Clear green-yellow gel |
| 3.28 | 1000/2 | 2010 | 5650 | Purification \| | Green-yellow gel |
| 3.29 | 1000/2 | 1840 | 5190 | Purification III | Green-yellow gel |
| 3.30 | 1000/2 | 4050 | 10900 | Purification I | Greyish viscous liquid. Solid at 1º C. |
| 3.31 | 1000/2 | 1860 | 4840 | Purification I | Greyish green gel |
| 3.32 | 1000/2 | 1370 | 3640 | Purification IV | Brown oil |
| 3.33 | 1000/2 | 1870 | 5090 | Purification IV | Brown oil |
| 3.34 | 1000/2 | 2650 | 7040 | Purification I | Greyish gel |
| 3.35 | 1000/2 | 2110 | 5840 | Purification I | Brown solid |
| 3.36 | 1000/2 | 3000 | 7130 | Purification III | Brown rubbery solid |
| 3.37 | 1000/2 | 3750 | 8600 | Purification III | Greyish solid |
| 3.38 | 1000/2 | 2400 | 6140 | Purification | Greyish gel |
| 3.39 | 1000/2 | 1340 | 3280 | Purification | Brown oil |
| 3.40 | 1000/2 | 3000 | 7130 | Purification | Brown solid |

It can be seen from table 3a and 3b that polymers with a weight-averaged molecular weight Mw of over 3000 g/mol can be obtained if pTSA is used as catalyst in an amount of over 0.1% by weight based on the total amount of reactants and catalyst. Polymers with a weight-averaged molecular weight Mw of over 10000 g/mol can be obtained if pTSA is used as catalyst in an amount of 1 to 2.5% by weight based on the total amount of reactants and catalyst and 3HPA is used as monomer. Form examples 3.45 and 3.46 it becomes clear, that the molecular weight can be increased significantly by adding tartaric acid.

TABLE 4
Melting point and melt enthalpy of some of the polymers

| | Melting | Enthalpie | Melting | Enthalpie |
|---|---|---|---|---|
| | point [° C.] | H [J g⁻¹] | point [° C.] | H [J g⁻¹] |
| Example | 1. heating (Tm1) | 1. Heating | 2. heating (Tm2) | 2. Heating |
| 3.25 | 6 | 24.2 | 7 | 22.5 |
| 3.27 | −13 | 37.7 | −13 | 39.0 |
| 3.28 | −13 | 29.2 | −15 | 29.3 |
| 3.29 | −13 | 27.8 | −14 | 27.9 |
| 3.31 | −11 | 43.1 | −11 | 45.3 |
| 3.34 | 16 | 64.44 | 16 | 69.74 |

TABLE 5
Glass temperatures of some of the polymers

| Example | Tg [° C.], heating | Tg [° C.], cooling |
|---|---|---|
| 3.32 | −64 | −65 |
| 3.36 | −27 | −27 |

From table 4 and 5 it becomes clear, that some of the polymers obtained are amorph (showing only a Tg) while others have a crystalline structure (showing a melting point).

### 5. Production of a Film/Foil

20 weight-% solutions of the product of each of the examples 3.21, 3.35, 3.36, 3.37, and 3.40 respectively in isopropanol were casted on a glass plate. The films obtained had a thickness of about 150 μm and were free of inclusions/bubbles. The films could be peeled from the glass plate by hand without being ripped to pieces. The produced films were flexible and non-sticky and had a flat to slightly rippled surface.

The experiment was repeated using the product of example 3.21 and using as solvent ethyl acetate and THF respectively. The films obtained were flexible and non-sticky and had a flat surface.

1. A process for preparing a polymer from at least one 3-hydroxy carboxylic acid as monomer characterized in that the 3-hydroxy carboxylic acid comprises at least 8 carbon atoms, preferably of from 10 to 24 carbon atoms and that the polymerisation reaction is conducted at a temperature of from 100° C. to 180° C., preferably of from 110° C. to 140° C. while removing water from the reaction mixture, and wherein 50 to 100 mol-% of the monomers used are 3-hydroxy carboxylic acids comprising at least 8 carbon atoms.

2. The process according to claim 1, characterized in that the monomer is selected from the group consisting of 3-hydroxy tetradecanoic acid (3-OH—C14), 3-hydroxy palmitic acid (3-OH—C16), 3-hydroxy dodecanoic acid (3-OH—C12), and 3-hydroxy decanoic acid (3-OH—C10) or its dimer (D-C10-C10).

3. The process according to claim 1, characterized in that it comprises a dimerization step conducted before the polymerisation reaction, wherein 3-hydroxy decanoic acid (3-OH—C10) is dimerized, preferably using one or more microorganisms.

4. The process according to claim 1, characterized in that a mixture comprising 3-hydroxy carboxylic acids is used as monomer, wherein the mixture comprises of from 50 to 80 parts by weight 3-hydroxy decanoic acid dimer (D-C10-C10), of from 5 to 15 parts by weight dimer obtained from 3-hydroxy decanoic acid and 3-hydroxy octanoic acid (D-C8-C10), of from 5 to 15 parts by weight hydroxy decanoic acid, of from 1 to 10 parts by weight dimer obtained from 3-hydroxy decanoic acid and 3-hydroxy dodecanoic acid (D-C10-C12) and of from 1 to 10 parts by weight dimer obtained from 3-hydroxy decanoic acid and 3-hydroxy dodecenoic acid (D-C10-C12:1).

5. The process according to claim 1, characterized in that one or more further hydroxy acids having less than 10 carbon atoms and not being 3-hydroxy carboxylic acids are used as co-components.

6. The process according to claim 5, characterized in that the co-component is selected from one or more alpha-hydroxy carboxylic acids or one or more carboxylic acids having two or more carboxyl groups or mixtures thereof.

7. The process according to claim 6, characterized in that glycolic acid or lactic acid is used as alpha-hydroxy carboxylic acids acid or tartaric acid, citric acid, or 1,2,3,4-butane tetracarboxylic acid is used as carboxylic acids having two or more carboxyl groups.

8. The process according to claim 1, characterized in that the polymerisation reaction is conducted in the absence of a catalyst.

9. The process according to claim 1, characterized in that the polymerisation reaction is conducted in the presence of a catalyst.

10. The process according to claim 9, characterized in that the catalyst is selected from Lewis acids, more preferably organic tin or titanium compounds, most preferably titan tetrabutanolate or tin octanoate), or Brönstedt acids, more preferably para-toluene sulfonic acid, inorganic acids, or acidic matrix material.

11. The process according to claim 1, characterized in that the polymerisation reaction is conducted in the absence of any microorganism.

12. The process according to claim 1, characterized in that the monomer and the co-components are dried in a drying step prior to the start of the polymerisation reaction.

13. The process according to claim 1, characterized in that the reaction product of the polymerisation reaction is further processed in a purification step.

14. The process according to claim 1, characterized in that 50 to 99 mol-% of the monomers used are 3-hydroxy carboxylic acids comprising at least 8 carbon atoms.

15. Mixture comprising dimers of 3-hydroxy carboxylic acid, characterized in that it comprises of from 50 to 80 parts by weight 3-hydroxy decanoic acid dimer (D-C10-C10), of from 5 to 15 parts by weight dimer obtained from 3-hydroxy decanoic acid and 3-hydroxy octanoic acid (D-C8-C10), of from 5 to 15 parts by weight hydroxy decanoic acid, of from 1 to 10 parts by weight dimer obtained from 3-hydroxy decanoic acid and 3-hydroxy dodecanoic acid (D-C10-C12) and of from 1 to 10 parts by weight dimer obtained from 3-hydroxy decanoic acid and 3-hydroxy dodecenoic acid (D-C10-C12:1).

16. A polymer comprising units based on 3-hydroxy carboxylic acid, comprising at least 8 carbon atoms, characterized in that of from 60 to 100 mol-% of the units are based on beta-hydroxy carboxylic acids, comprising at least 8 carbon atoms.

17. The polymer comprising units based on 3-hydroxy carboxylic acid, comprising at least 8 carbon atoms, characterized in that of from 60 to 100 mol-% of the units are based on beta-hydroxy carboxylic acids, comprising at least 8 carbon atoms, characterized in that it is obtained by a process according to claim 1.

18. The polymer according to claim 16, characterized in that the polymer has a weight averaged molecular weight Mw, determined by the method given in the description, of at least 1500 g/mol, preferably of from 3000 to 15000 g/mol.

19. A film, foil, flexible packaging, or barrier coating comprising polymers according to claim 16.
